(19) United States
(12) Patent Application Publication
(10) Pub. No.: US 2026/0226778 A1
(43) Pub. Date: Aug. 6, 2026

(54) Frame assembly for sliding doors

(71) Applicant: Roccon Silvio Srl, Cornuda (TV) (IT)

(72) Inventor: Giancarlo Cinel, Cornuda (TV) (IT)

(21) Appl. No.: 19/458,313

(22) Filed: Jan. 23, 2026

(30) Foreign Application Priority Data
Jan. 31, 2025 (IT) 102025000001851

(51) Int. Cl. E05D 15/06

(52) U.S. Cl. CPC E05D 15/0621

(57) ABSTRACT

A frame assembly to be installed in an opening delimited by one or more floor and/or ceiling portions includes: a sliding door configured to slide along a predetermined sliding direction and having a lower edge portion to be directed toward the floor and an upper edge portion to be directed toward the ceiling; a first frame configured to be positioned at the opening below the lower edge portion and/or above the upper edge portion of the sliding door; and a guide system associated with the sliding door and the first frame to enable the selective sliding of the door along the predetermined sliding direction. The first frame includes an end seat facing toward the lower and/or upper edge portion of the sliding door and configured to house floor and/or ceiling portions so as to enable the positioning of the first frame completely below the floor and/or completely above the ceiling.

### FIELD OF THE INVENTION

The present invention finds application in the technical sector of fixtures and has as its object a frame assembly intended to be installed in an opening formed in a building or other similar structure.

### BACKGROUND OF THE INVENTION

As is known, in the technical sector of fixtures in the civil or industrial field, the need to create frame structures whose aesthetic line is defined so as to be functional to the environment in which said structure is to be installed is increasingly felt.

In particular, in current practice it is very important to reduce to a minimum the parts of the frame that can protrude from the walls that delimit the passage formed in the building.

Firstly, the absence of protruding elements with respect to the walls (or with respect to the floor or the ceiling) increases the user's safety due to the fact that the latter does not run the risk of accidentally interacting with their body against sharp or potentially dangerous parts for their own safety.

To fully understand the usefulness of a “clean” frame structure, i.e., without protrusions with respect to the walls that delimit the opening, it is sufficient to think of the behavior of a child in the first age group, still lacking stability in walking and unaware of the consequences that could occur if some parts of his body (for example the hands) were to come into contact with potentially dangerous shaped profiles.

The absence of protruding elements with respect to the floor level and the walls considerably increases the safety standards of the entire living or walkable space, also solving the problem of possible tripping that the feet of a person (this time of any age group) could encounter during the crossing of the passage (due to the presence of a frame profile protruding from the ground).

Furthermore, a frame structure without protrusions with respect to the plane defined by the walls allows its aesthetic line to be adapted to any type of environment, thus removing almost the entirety of the frame from the observer's view, so as to generate a visual effect that is particularly striking to the eyes of an observer and such as to give an impression of “enlargement or amplification” of the space surrounding the frame structure.

However, the design of a frame structure configured to be almost totally recessed below the ceiling plane or below the floor plane involves overcoming considerable technical constraints, which are not always easily achievable.

From EP2525033, a frame structure is known, provided with a frame for sliding doors in a door opening. This structure has an external surface designed to contain at least one wall comprising a fixed frame and an intermediate element, suitable for being fixed to the wall and cooperating with displacement means associated with the fixed frame. In this way, the intermediate element allows the displacement of said wall with respect to the fixed frame to be promoted. A slit is also present comprising at least one open groove, while the intermediate element comprises at least one main longitudinal flange passing through the groove and at least one longitudinal portion connected to one of the ends of the longitudinal flange. The frame of the structure is intended to cooperate with the displacement means and is positioned entirely above or below the external surface in such a way that said fixed frame does not present any protruding element outside the door opening.

From EP2712382, a frame structure for sliding walls in an opening is known, defining an external surface comprising a fixed frame, an intermediate element intended to be fixed to said wall, and a movement means that allows the wall to move with respect to the fixed frame. The frame is characterized by the fact that the opening comprises at least one through-groove and the intermediate element passes through said through-groove. A slider is then provided and connected to one of the ends of the intermediate element, and a movement means engages with the slider and/or with the fixed frame so as to move the wall along a predetermined path. The fixed frame, being positioned entirely above or below the external surface, ensures that the fixed frame does not expose any protruding element from the opening.

However, both of the structures described above present some non-negligible drawbacks.

Firstly, these frame structures have a limited structural resistance which does not make them suitable for installation when the passages formed in the building have considerable dimensions.

Furthermore, these frame structures, while hiding some parts of the frame from view, maintain more than one component outside the floor or ceiling, which, in fact, degrades the overall visual cleanliness offered by the structure.

Moreover, recessing the frame below the floor plane or the ceiling plane is not easily obtainable, since there are no elements of the structure that allow the parts of the ceiling and floor that cover the previously recessed frames to be retained and anchored.

### SUMMARY OF THE INVENTION

The present invention intends to overcome the technical drawbacks mentioned above by providing a particularly efficient and high-performing frame structure.

In particular, the main object of the present invention is to provide a frame structure capable of presenting high mechanical stiffness even when it is intended to be installed in passages of large dimensions formed in a building.

A further object of the present invention is to provide a frame structure that has particularly small installation dimensions.

Another object of the present invention is to provide a frame structure that can be installed in a modular version in a particularly simple and fast way.

A further object of the present invention is to provide a frame structure that can be easily recessed under the plane of the walls that delimit the opening formed in the building, while at the same time allowing the parts of said walls intended to cover the previously recessed components to be supported.

Another object of the present invention is to provide a frame structure that is particularly easy to install by a specialized operator.

Yet another, not least, object of the present invention is to provide a frame structure capable of ensuring high thermal insulation between the environments located on opposite sides with respect to the passage formed in the building.

These objects, together with others that will be better clarified later, are achieved by a frame assembly of the type according to claim 1.

Other objects that will be better described later are achieved by a frame assembly according to the dependent claims.

### BRIEF DESCRIPTION OF THE DRAWINGS

The advantages and characteristics of the present invention will emerge clearly from the following detailed description of some preferred but not limiting configurations of a frame assembly with particular reference to the following drawings:

FIG. 1 is a front view of a frame assembly in a first embodiment;

FIG. 2 is a front view of a frame assembly in a second embodiment;

FIG. 3 and FIG. 4 are sectional views of the frame assembly of FIG. 1;

FIGS. 5 to 9 are sectional views of the frame assembly of FIG. 2 provided with some variants in specific details;

FIG. 10 is a sectional view of a further variant of the frame assembly of FIG. 2;

FIG. 11 is a perspective view of a detail of FIG. 10;

FIG. 12 and FIG. 13 are perspective views of a further detail usable in the assembly of FIG. 1 and FIG. 2;

FIG. 14 is a perspective view of a final detail of the frame assembly of FIG. 1 and FIG. 2.

### DETAILED DESCRIPTION OF EMBODIMENTS OF THE INVENTION

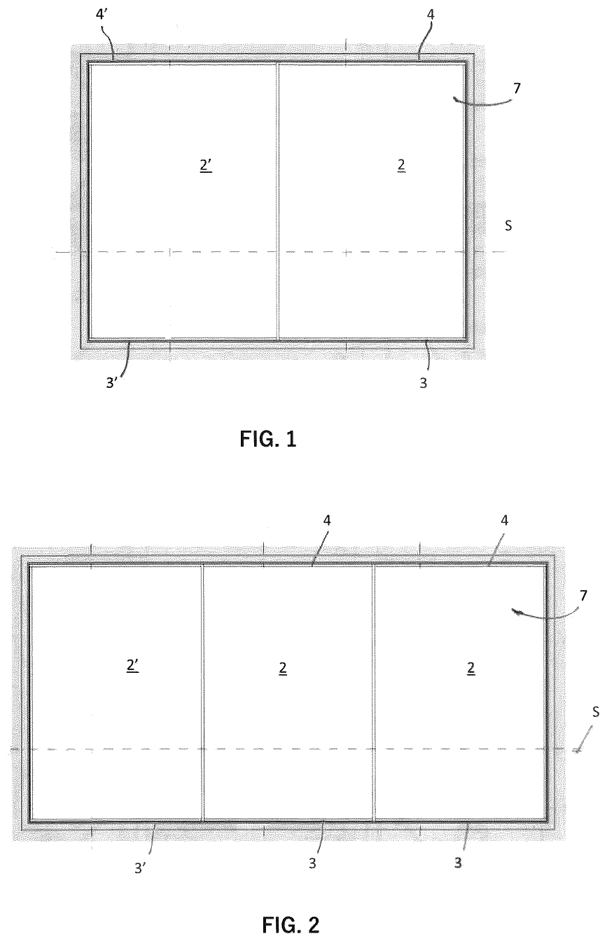

The present invention has as its object a frame assembly for sliding doors, for example of the type visible in FIG. 1 and FIG. 2.

In particular, this frame structure, indicated globally with the reference number 1, may be installed in a building in order to promote the selective closure of an opening (or passage) formed in the building itself.

The building in which the opening or passage is formed may be of any type; for example, this building may be made of masonry (thus using bricks covered with plaster), or it may be realized using construction material of a different type such as, for example, typically wood, steel, composite materials, biocompatible materials, etc.

Furthermore, the passage or opening may be realized in an external and/or internal wall of the building to connect two or more contiguous or adjacent environments.

It is also understood that the present frame assembly 1 is configured to promote the selective closure of at least a portion of the passage or opening, that is such an assembly can selectively assume both a closed configuration, i.e., suitable for preventing a user from crossing the passage, and an open (or partially open) configuration in which a user is allowed to cross the passage in order to move from one environment to another.

In the most essential configuration, the frame assembly 1 object of the present invention comprises:
at least one door 2 intended to slide along a predetermined sliding direction S; said door 2 is provided with at least one lower edge portion 3 intended to be directed towards the floor and an upper edge portion 4 intended to be directed towards the ceiling;
at least a first frame 5 intended to be positioned at the opening below the lower edge portion 3 of the sliding door and/or above the upper edge portion 4 of the sliding door 2;
guide means 6 associated with the sliding door 2 and the first frame 5 to allow the selective sliding of the door 2 along the sliding direction S.

The components indicated above will be described in greater detail below.

### Sliding Door

As best seen in FIG. 1 and FIG. 2, the frame assembly 1 comprises at least one mobile door 2 sliding along a predetermined sliding direction, indicated in the figures with the reference letter S.

The frame assembly object of the invention, therefore, always includes at least one sliding door 2 (or a plurality of sliding doors 2), while the presence of one or more fixed doors 2′ is optional and they may, therefore, not be provided.

For example, in the configuration of FIG. 1, a single sliding door 2 and a single fixed door 2′ are provided.

In the configuration of FIG. 2, instead, two sliding doors 2 along different sliding directions S and a single fixed door 2′ are provided.

Furthermore, all the doors 2, 2′, whether mobile or fixed, present a panel (or a similar laminar element intended) to close the surface enclosed by the door itself.

In general, this panel can be constituted by one or more glass sheets 7 suitable for defining a double-glazing system. For example, the panel of one or more doors 2 may be constituted by a pair of insulating glass panes suitably spaced from each other so as to define a single chamber (single-chamber insulating glass), or the same panel may be constituted by three insulating glass panes spaced from each other so as to define two chambers (double-chamber insulating glass).

In the configuration of the structure 1 illustrated in the Figures, the door comprises a central panel made of a single-chamber insulating glass 7; however, it is evident that such a door can be made with different panels, for example with double-chamber insulating glass 7.

In general, the thickness of a single-chamber insulating glass 7 used in the door installed in the assembly according to the invention may be between 20 mm and 50 mm.

In the case where the door 2 supports a double-chamber insulating glass panel 7, its thickness may be between 40 mm and 70 mm.

It is also important to note that the door 2 can be made of panels formed of any material, other than glass. For example, the door 2 may comprise one or more panels made of wood or polymeric material.

Furthermore, the frame assembly 1 object of the present invention may be configured to allow the installation of sliding doors 2 and fixed doors 2′ having particularly large dimensions.

For example, the doors 2, 2′ may have a substantially rectangular plan shape whose sides have dimensions in the order of meters (e.g., 1 m; 1.5 m; 2 m; 2.5 m or larger).

Therefore, all the components of the assembly described below have dimensions and materials chosen so as to guarantee high structural resistance, such as to allow the support of particularly bulky and heavy sliding doors 2.

### First Frames

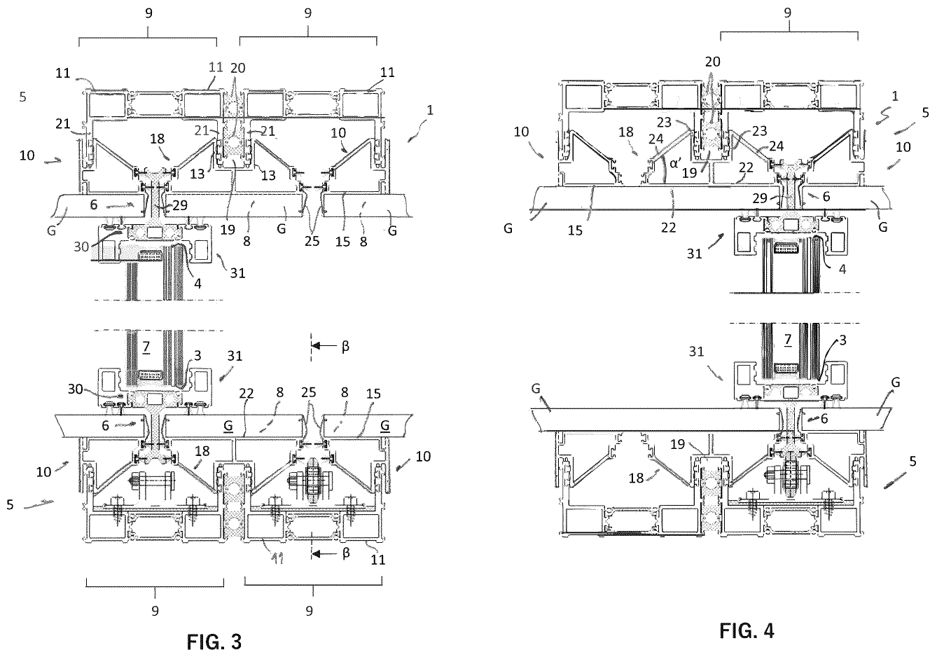

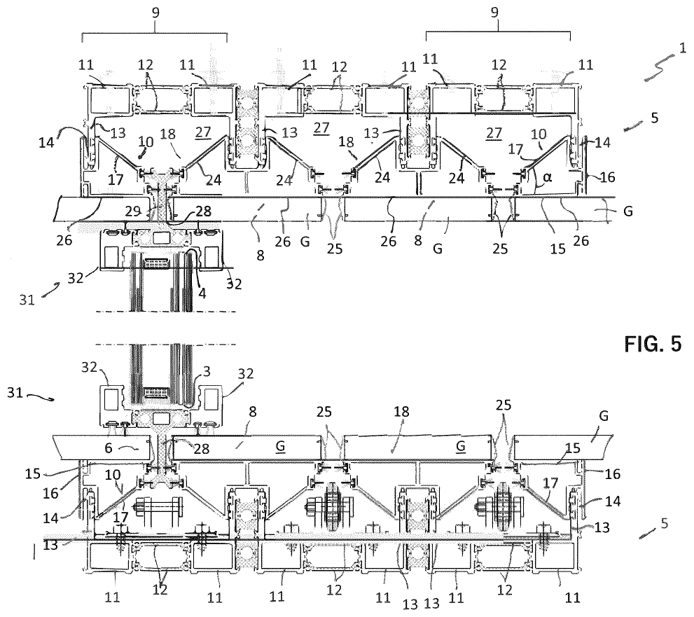

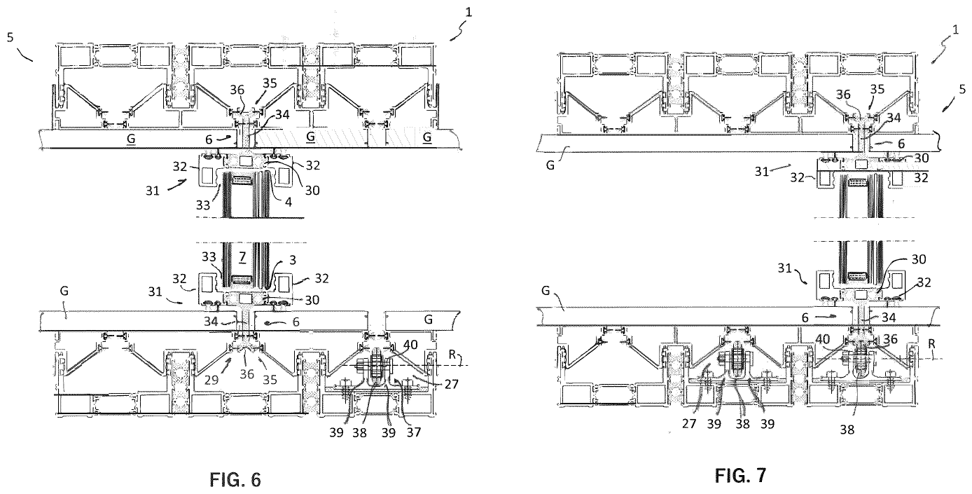

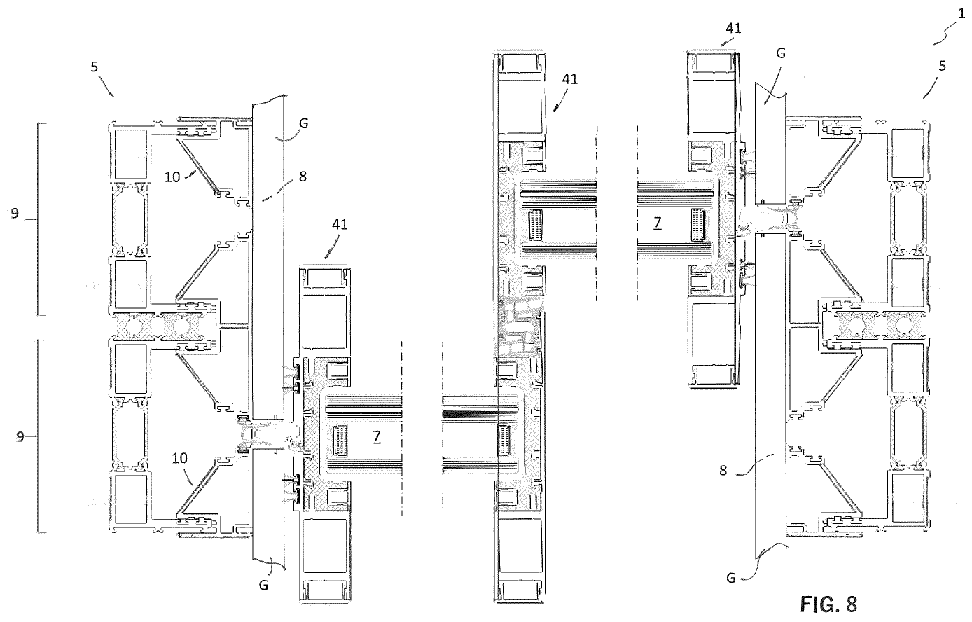

These components of the system are best seen in FIG. 3, FIG. 4 and FIG. 5.

The first frames 5 are first of all configured to be positioned below and above the lower edge portion 3 and upper edge portion 4 of each sliding door 2.

In the case where the assembly also comprises fixed doors 2′, the first frames 5 are arranged below and above the lower edge 3′ and the upper edge 4 of said fixed doors 2′.

Therefore, the first frames 5 are arranged at least in pairs as they are installed above or below the doors 2 that are part of the assembly 1.

In general, all the doors 2, 2′ are installed so as to maintain a substantially vertical position, thus directing their lower edge 3 and upper edge 4 in the vicinity (or in proximity) of the ceiling and floor that delimit the passage.

In this way, the frames 5 of a respective pair are arranged at the floor and ceiling, so as to remain below or above the lower 3 and upper 4 edge portions of the sliding door 2.

The first frames 5 are configured to be recessed within a specific space created below the level (or plane) defined by the floor and ceiling that delimit the passage.

This space is not visible in the drawings but has a depth chosen in such a way as to completely house the first frames 5 within it, so that no part of the latter protrudes with respect to the floor plane or the ceiling plane

The first frames 5, therefore, are configured to confer high stability and structural rigidity to the entire assembly 1, although they maintain particularly small dimensions.

This is made possible thanks to the particular structure of the first frames 5, which will be better described below.

In particular, according to a peculiar aspect of the invention, the first frames 5 of each pair have an end seat 8 intended to be directed towards the lower edge portion 3 and/or the upper edge portion 4 of the sliding door 2.

This seat 8 is configured to house respective portions of floor and/or ceiling, globally indicated in the Figures with the letter G, so as to allow the positioning of the pair of first frames 5 completely below and/or completely above the level of the floor and/or ceiling.

As best seen in the Figures, in fact, the end seat 8 formed in the first frames 5 allows the housing of slabs or panels of predetermined material (or pieces of such slabs or panels), suitable for defining the ceiling or the floor of the opening formed in the building.

In this way, therefore, the first frames 5 will be totally recessed below the floor or above the ceiling in such a way that no element of them can protrude from the floor or from the ceiling; moreover, no part of the first frames 5 is visible to a user observing the opening formed in the building from the outside.

In particular, the first frames 5 may comprise at least one base element 9 and a plurality of lateral profiles 10 operatively connected to at least one of said base elements 9.

The base element 9 may be constituted by a pair of shaped profiles 11 reciprocally joined together through one or more intermediate elements 12.

The shaped profiles 11 may have a cross-sectional shape substantially of a “lowercase b”, i.e., containing a central part with a closed and substantially rectangular section, from which a substantially rectilinear protruding edge 13 extends.

The shaped profiles 11 are arranged in a substantially specular position with respect to a plane of symmetry β passing through the centerline of the base element 9.

The protruding edges 13 of the shaped profile 11 are suitable for defining the ends of the base element 9 when said shaped profiles 11 are joined together by one or more intermediate elements 12.

The intermediate elements 12 may be constituted by profiles having a cross-sectional shape substantially “of an omega”; these elements can be joined to the shaped profiles 11 through an interlocking connection made in the same. Suitably, each base element 9 may comprise a pair of intermediate elements 12 intended to connect a pair of shaped profiles 11 arranged specularly with respect to the centerline plane β.

The coupling between the intermediate elements 12 and a pair of shaped profiles 11 allows for obtaining a unitary element, here named base element 9. The base element 9 illustrated in the Figures has a pair of shaped profiles 11 joined by the use of two intermediate elements 12.

The shaped profiles 11 may be made of a metal alloy containing aluminum, while the intermediate elements 12 may also be profiles obtained by extrusion of a polymeric material, preferably polyamide or other similar material.

The lateral profiles 10 may be coupled to the base element 9 at the protruding edges 13 associated with the shaped profiles 11.

The lateral profiles 10 may be coupled to the respective protruding edges 13 through an interlocking connection made in the same lateral profiles 10; this interlocking connection is suitable for defining a passage 14 for the sliding insertion of the protruding edges 13 of the shaped profiles 11.

Suitably, the lateral profiles 10 may comprise a substantially flat upper external wall 15 and a lateral wall 16 substantially orthogonal to the upper external wall 15. At the lateral wall 16, the passage 14 is formed for the sliding insertion of the protruding edges 13 of the shaped profiles 11.

A connecting wall 17 is also provided, having a predetermined shape suitable for connecting the substantially flat upper wall 15 to the lateral wall 16 in which the passage 14 is made.

At least a portion of the connecting wall 17 is inclined with respect to the upper external wall 15; in general, the inclination angle α of this portion of the connecting wall 17 with respect to the substantially flat external wall 15 may be between 30° and 50°.

Suitably, each first frame 5 may comprise at least one intermediate profile 18, suitably shaped and provided with a central recess 19 suitable for allowing the housing of two respective protruding edges 13 associated with a pair of base elements 9 arranged in a mutually adjacent position.

When two protruding edges 13 belonging to different base elements 9 are inserted into the recess 19 of a single intermediate profile 18, what is obtained is a unitary assembly constituted by the union of these three elements (two base elements 9 and one intermediate profile 18).

In particular, when the base elements 9 are arranged in an adjacent position, the same elements may be further joined also by at least one profile 20 made of insulating material and arranged at the external surface 21 of the protruding edges 13 of the base elements 9 which are in a mutually facing position.

In the configuration of the first frames 5 visible in the Figures, a pair of first insulating profiles 20 is provided, suitable for joining two respective base elements 9 through suitable interlocking connections made on the external surface 21 of the elongated edges 13.

The intermediate profiles 18 are generally interposed between the plurality of lateral profiles 10.

By inserting the protruding edges 13 belonging to different base elements 9 into the central recess 19 of one or more intermediate profiles 18, it is possible to obtain a series of base elements 9; the first and the last base element 9 of this series define the terminal elements of the said series, at which a free protruding edge 13 is present, i.e., one that is not inserted into the central recess 19 of an intermediate profile 18. All the other base elements 9, instead, will have respective protruding edges 13 inserted in the recesses 19 of different intermediate profiles 18.

In this case, the connection of the series of base elements 9 with a pair of lateral profiles 10 is provided; the latter will be coupled to the base elements 9 at the free protruding edges 13 (i.e., the edges 13 that are not inserted in the central recess in the intermediate profile) of the base elements 9 that form the terminals of the series.

In the configuration of the first frames visible in the Figures, the series is formed by a pair of base elements 9 arranged in an adjacent position and joined together, respectively, by two insulating profiles 20 and by a single intermediate profile 18 (thus forming a unitary assembly).

The lateral profiles 10 are connected to the free elongated edge 13 of each base element 9. Therefore, observing the first frames 5 along a direction of observation from left to right, what is found is first a lateral profile 10, then an intermediate profile 18, and finally another lateral profile 10. In other words, the intermediate profile 18 is interposed between the two lateral profiles 10.

The intermediate profile 18 may also have a substantially flat external wall 22, suited to be directed towards the sliding door 2 when the first frames 5 are recessed in the space formed in the floor or ceiling.

The external wall 22 of the intermediate profile 18 may be connected to the walls 23 that define the recess by means of a pair of connecting walls 24.

Similarly to what has already been described for the lateral profiles 10, the connecting walls 24 of the intermediate profiles 18 may also have at least one inclined portion suitable for joining the end of the flat external wall 22 to the recess 19.

In general, the inclination angle α′ of this portion of connecting wall 24, determined with respect to the flat external wall 22, may be between 30° and 50°.

Suitably, the end seat 8 may be formed on each lateral profile 10 and/or on each intermediate profile 18.

In particular, the end seat 8 may be formed at the external wall 15, 22 of the lateral profiles 10 and/or the intermediate profiles 18.

Each lateral profile 10 and each intermediate profile 18 may also comprise a raised edge 25 that extends from the external wall 15, 22 at an end of the same.

The raised edge 25 formed in each lateral profile 10 or in each intermediate profile 18 may extend along a development plane substantially orthogonal to the development plane on which the external wall 15, 22 lies.

Therefore, the surface 26 of the external wall 15, 22 that is comprised between the raised edges 25 defines the end seat 8 present in each lateral profile 10 and/or each intermediate profile 18 associated with the first frames 5.

The end seat 8 thus obtained is therefore directed towards the sliding door 2 or the fixed door 2′ and can be suitable for housing portions of ceiling or floor P, generally laminar, suitable for completely filling said seat 8 so as to completely hide the first frames 5 from the view of a user observing the passage from the outside.

Suitably, in the assembled position, the frame 5 may define an internal cavity 27 delimited inferiorly by the base element 9 and superiorly by the connecting wall 17, 24 present in the lateral profile 10 and/or in the intermediate profile 18. As will be better described below, further components of the frame assembly 1 are housed inside this cavity 27.

The previously described configuration allows for obtaining first frames 5 capable of greatly reducing dimensions and particularly suitable for being completely inserted (or recessed) inside the specific spaces created at the floor or ceiling.

For example, in the configuration of the frame assembly 1 illustrated in the Figures, the first frames 5 may have a greatly reduced width I1 and generally comprised between 60 mm and 90 mm.

Consequently, the excavation that must be carried out at the floor or ceiling to create the housing space for the first frames 5 will have dimensions similar to the latter (or slightly larger).

Suitably, the first frames 5 of the type described above may also be installed at the lateral edges (or lateral walls) that delimit the opening. In this case, therefore, the first frames 5 may be installed in all the edges/walls that delimit the opening, thus delimiting it perimetrically on all its sides. In general, a pair of first frames 5 may be arranged at the floor and ceiling (typically along a substantially horizontal installation direction), and another pair of first frames 5 may be arranged at the walls or lateral edges of the opening (typically along a vertical installation direction).

### Guide Means

The expression “guide means” is intended to indicate all the components associated with the assembly 1 that allow the doors 2 to slide selectively along their sliding direction S.

The expression “to slide selectively” means the movement performed by the door 2 along its sliding direction S following the application of a force or external interaction applied by the user.

Firstly, the guide means 6 comprise at least one slot 28 formed in correspondence with the first frames 5; this slot 28 extends along the sliding direction S of the door 2.

In accordance with the configuration of the assembly 1 illustrated in the Figures, for each sliding door 2 a pair of substantially parallel slots 28 is provided, both of which extend along the sliding direction 10 of said door 2. These slots are preferably formed at the ceiling and/or the floor.

Furthermore, the slots 28 of each pair may be aligned with each other, i.e., the median plane passing through one of said slots 28 is also the median plane of the other slot 28.

The slots 28 are defined as empty spaces left between a pair of profiles 10, 18 used in the first frames 5.

For example, the slot 28 may be obtained by leaving an appropriate spacing between two lateral profiles 10 arranged in an adjacent position.

Alternatively, the slot 28 may also be obtained by leaving an appropriate spacing between a lateral profile 10 and an intermediate profile 18 arranged in an adjacent position.

Furthermore, the slot 28 may also be obtained by leaving an appropriate spacing between a pair of intermediate profiles 18 arranged in a mutually facing position.

Typically, the slot 28 may have a relatively small width, generally comprised between 10 mm and 20 mm.

The slots 28 are the only elements of the assembly 1 (together with the sliding doors 2 and/or fixed doors 2′) that are visible to a user located outside the passage.

Suitably, the guide means 6 comprise at least one centering element 29 associated with each sliding door 2 and suited to be at least partially inserted inside the slot 28 formed on the first frames 5. According to a preferred configuration of the centering element 29, the latter may be made of reinforced polyamide or another material having the same chemical-physical characteristics.

In particular, the centering element 29 may have a portion 30 protruding from the slot, i.e., a portion that extends out of the slot and is therefore placed outside the floor and/or ceiling. The protruding portion 30 of the centering element 29 is connected to the lower frame 31 and the upper frame 31 of the door sliding 2.

The lower frame 31 and the upper frame 31 of the sliding door 2 represent those parts of the assembly 1 suitable for allowing the housing of the lower edge portion 3 and the upper edge portion 4 of the door 2.

In the configuration illustrated in the Figures, the frame 31 is formed by a pair of metallic profiles 32 suitable for defining a slight recess within which it is possible to place the lower edge portion 3 and the upper edge portion 4 of the door 2.

The door 2 is then solidly joined to the lower frame 3 and the upper frame 4 by the application of silicone 33 or other similar polymeric resins.

The metallic profiles 32 of the upper frame 31 are arranged in a substantially specular position with respect to a median plane passing through the door 2.

These profiles 32 are joined together through the portion 30 of the centering element 29 that protrudes from the slot 28.

The protruding portion 30 of the centering element 29 may have a reduced thickness and a significantly increased width so as to define a thin element which is at the same time provided with a rigidity such as to promote the union of the profiles 32 that define the lower frame 31 and the frame 32.

In fact, suitable recesses are provided on these elements 30, 32 in order to allow the sliding insertion of each profile 32 to the protruding portion 30 of the centering element 29. In particular, the profiles 32 are inserted slidably from opposite sides with respect to the protruding portion 30.

The sliding insertion of the profiles 32 on the protruding portion 30 of the centering element 29 allows for obtaining a unitary element suitable for defining the lower frame 31 and the upper frame 31 of the sliding door 2.

In the vicinity of the centerline of the protruding portion 30 of the centering element 29 extends an elongated shank 34 having a particularly reduced thickness, such as to allow its passage through the slot 28.

For example, the thickness of this shank 34 may be between 4 mm and 8 mm.

The end of the shank 34, arranged on the opposite side with respect to the protruding portion 30, is positioned below the slot 28 in proximity to the cavity 27 present in the first frames 5 (i.e., the end of the shank 34 opposite to the protruding portion 30 is located above and/or below the floor and/or ceiling).

This end has a substantially enlarged head 35 on which a substantially semi-circular surface 36 is formed, facing towards the base element 9.

The guide means 6 may comprise one or more sliding elements 37 suitable for interacting with the centering element 29 so as to allow the door 2 to slide in the respective slot 10 along the sliding direction S.

In particular, the sliding elements 37 may be constituted by a plurality of wheels 38 arranged inside the cavities 27 present within the first frames 5 and freely rotating with respect to a central rotation axis R.

Inside these cavities 27, in fact, supports 39 may be placed, having a substantially “U”-shaped cross-section and anchored to the base element 9 by means of suitable screws or bolts.

The wheel 38 may be housed in the “U”-shaped portion of said supports 39 and will be anchored to the supports themselves by means of a central stem 40 arranged along the rotation axis R.

In this way, the wheel 38 can rotate freely around said stem 40 while remaining integral with the support 39.

Suitably, the wheel 38 may be constituted by a bearing, possibly covered by a layer of polymeric material.

The semi-circular surface 36 formed on the enlarged head 35 of the centering element 29 may be intended to come into contact with the external surface of the wheel 38 so as to slide on the latter during the movement that the door makes along the sliding direction S following the application of a force by the user.

In particular, during the sliding of the door 2 along the sliding direction S defined by the slot 2, the interaction between the semi-circular surface 36 (formed on the head 35 of the centering element 29) and the wheel 38 generates the free rotation of the latter around its own rotation axis R (i.e., around the stem 40) with a direction that depends on the direction of movement of the door (clockwise if the door 2 moves from left to right; counter-clockwise if the door 2 moves from right to left).

Furthermore, the support of the head 35 of the centering element 29 on the wheels 38 allows at least part of the weight of the door 2 to be discharged onto the first frames, in particular onto the base elements 9.

In a preferred version of the frame assembly object of the present invention, it is possible to provide for the use of guide means 6 comprising a plurality of wheels 38, each of which is mounted on the corresponding support 39 and rotatable on its own central stem 40 around the rotation axis R. Each wheel 38 may be spaced from the successive wheel 38 by a predetermined pitch so as to define a plurality of wheels distributed over the entire width of the mobile door 2, thus promoting its complete support during the entire excursion that the latter can selectively perform along the sliding direction S following the application of an external force impressed by a user.

### Second Frames

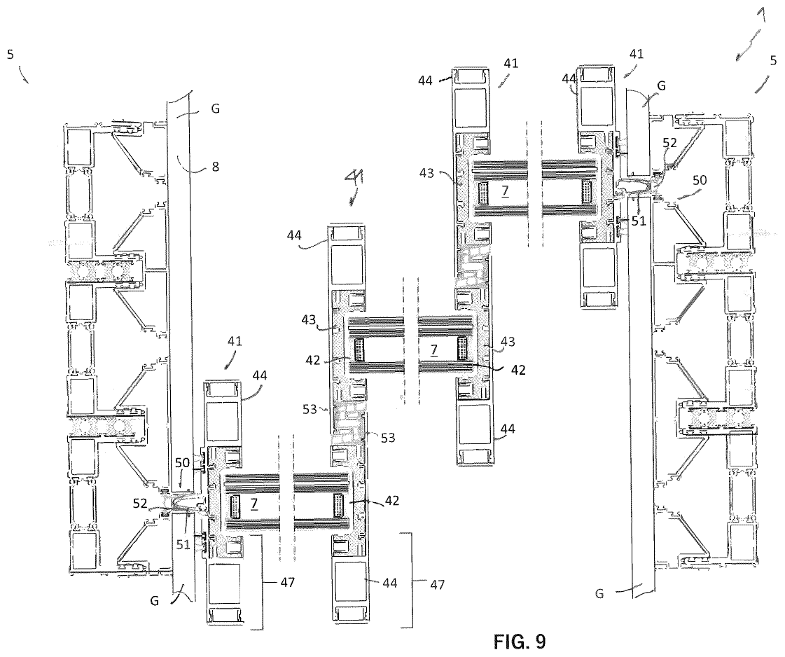

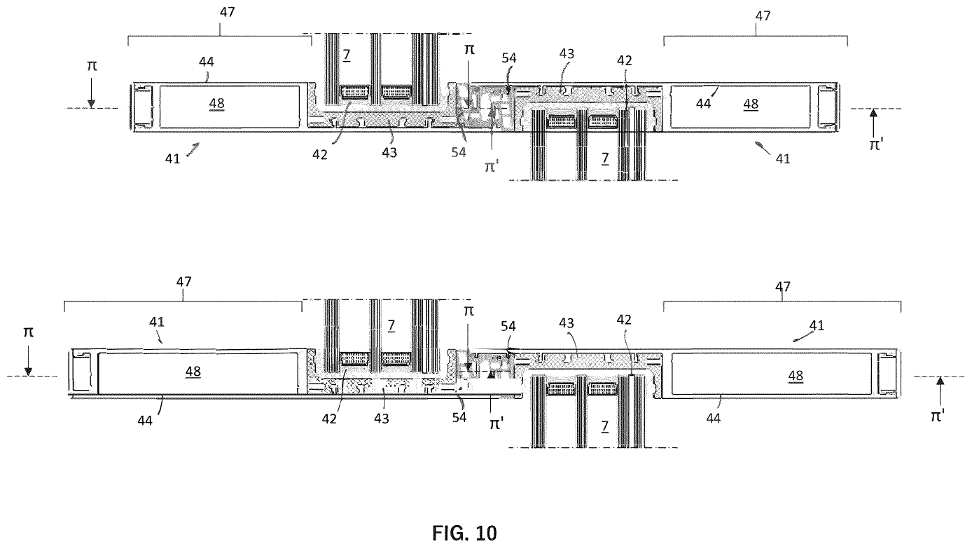

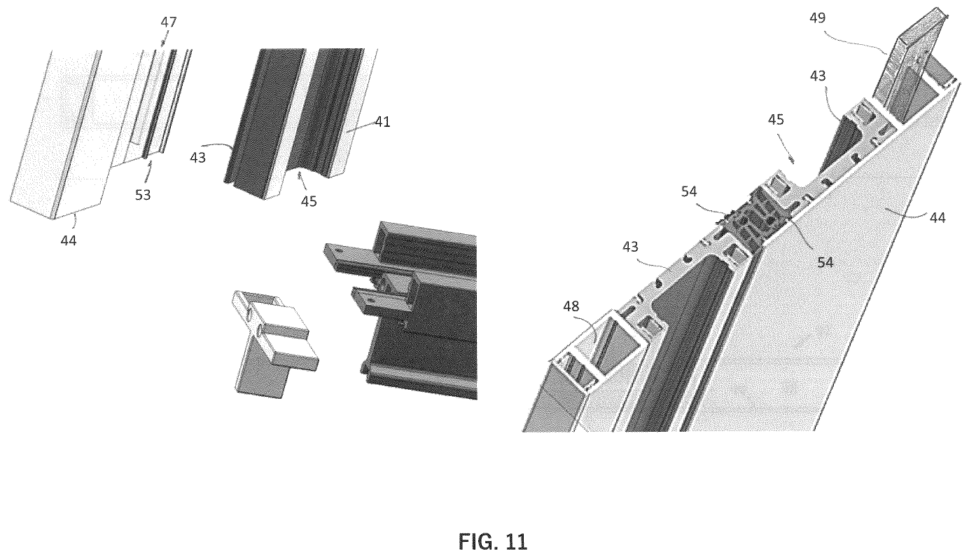

These components of the assembly are best seen in FIG. 8, FIG. 9, FIG. 10, and FIG. 11.

The assembly 1 according to the invention may comprise at least one second frame 41 (for example, a pair of second frames 41) configured to accommodate the lateral edge portion 42 of the panel comprised in each sliding door 2.

Each second frame 41 may comprise a profiled element 43 made of composite material and a respective elongated profile 44 made of metallic material.

As best seen in FIG. 11, the profiled element 43 made of composite material may comprise a groove 45 suitable for allowing the insertion of the lateral edge portion 42 of the panel (typically glass sheets) of the sliding door 2.

The lateral edge portion 43 of the panel may then be permanently connected to the profiled element 43 by the application of silicone 33 or other seminal material.

The profiled element 43 may be made of a composite material obtained from a fiber-reinforced polymeric material.

For example, the profiled element 43 may be obtained from a mixture of a polymeric resin reinforced with glass fibers. This type of material is generally indicated in technical jargon by the term “pultrusion,” which is the profiling technique of materials that allows obtaining a profile with a predetermined cross-sectional shape by combining different base elements (in this case, a polymeric resin and glass fibers).

The elongated profile 44 made of metallic material may have a cross-sectional shape suitable for defining a housing 41 for the profiled element 44 made of composite material.

Furthermore, the elongated profile 44 may be made of a metal alloy containing aluminum.

The elongated profile 44, in addition to housing the profiled element, may define a protruding portion 47 with respect to the central panel of the door 2, i.e., a portion 44 arranged along a corresponding development plane substantially orthogonal to the development plane of the central panel of the door.

This protruding portion 47 may be gripped by the user in order to promote the movement of the door 2 along the corresponding sliding direction S in both directions of movement.

The realization of second frames 41 formed by the coupling of an elongated profile 44 made of metallic material and a profiled element 43 made of composite material contributes to defining a particularly light frame structure (in consideration of its large dimensions) but at the same time particularly resistant and having high structural solidity.

To further increase the structural rigidity of the second frames 41, it is possible to realize an elongated profile 44 with a cross-sectional shape such as to provide at least one closed part and provided with an internal cavity 48.

Inside this cavity 48, it is possible to insert reinforcing elements 49, generally constituted by profiles made of aluminum. The reinforcing elements 49 allow for further increasing the mechanical and structural rigidity of the second frames 41.

Further components of the frame assembly 1 object of the present invention will be described in detail below.

### Coupling Means

The assembly 1 may also comprise coupling means 50 suitable for promoting the reciprocal coupling of a sliding door 2 with another sliding door 2, or the reciprocal coupling of a sliding door 2 with a fixed door 2′, or again, the reciprocal coupling of a sliding door 2 with the first frames 5 arranged at the lateral walls of the opening and/or the ceiling or floor.

In general, the doors 2 are configured to slide along a substantially horizontal sliding direction S; in this case, the coupling means 50, in addition to providing for the possible coupling of two respective doors 2 that slide along respective horizontal sliding directions S, also provide for the coupling of each respective door with the first frames 5 arranged at the lateral walls of the passage formed in the building.

The coupling means 50 are configured to promote a temporary and removable coupling between two doors 2, or between a door 2 and the first frames 5.

In this way, the coupling means 50 allow for at least partially closing the passage formed in the building through the interaction that a door 2 can promote with another door 2, 2′ or with the first frames 5 arranged at the lateral walls of the passage itself.

In a first embodiment, the coupling means 50 provide for the realization of a male element 51 integrally connected to the second frame 41 associated with one or more sliding doors 2.

The male element 51 may be connected to the second frame 41 intended to cover the lateral edge 42 of the central panel of the door 2.

In addition to the male element 51, a female element 52 is provided, which can be integrally anchored to a second frame 41 associated with a different door 2 that slides along the same direction S along which the door comprising the male element 51 also slides.

In other words, in the case where two or more doors 2 of the assembly are intended to slide along the same sliding direction S (and therefore a single slot 28 is provided for both), it is possible to apply the male element 51 and the female element 52 to the second frames 41 of said doors, which can be brought together during their reciprocal sliding, so as to be arranged in a close and mutually facing position.

In this way, when the doors 2 are pushed one against the other, the male element 51 can be inserted at least partially inside the female element 52 to define a substantially airtight closure with respect to the environments connected through the passage formed in the building.

The interaction of the male element 51 with the female element 52 is, however, temporary and removable since the user can promote the disengagement of these elements 51, 52 by applying a pair of opposing forces to the doors.

It is therefore evident how the coupling of the male element 51 inside the female element 52 allows promoting the closure of the passage through the abutment of multiple sliding doors 2 along the same sliding direction S.

Following what has just been described, it appears evident how it is possible to apply the female element 52 to the first frames 5 that cover the lateral walls of the passage formed in the building.

This situation, visible in FIG. 8 and FIG. 9, allows promoting the coupling of a respective sliding door 2 (provided with a male element 51 arranged in the second frame 41 facing the lateral wall of the passage) with the first frames 5 arranged at the lateral wall of the passage formed in the building (identifiable as the first frames 5 arranged further to the right and further to the left in the respective FIG. 8 and FIG. 9).

Suitably, the coupling means 50 may be configured to promote the reciprocal coupling of two or more sliding doors 2 suitable for moving selectively along different sliding directions S, i.e., parallel but offset sliding directions S.

This condition is visible in FIG. 8, FIG. 9, and FIG. 10.

In this case, the protruding portions 47 associated with the second frames 41 mounted on respective contiguous doors 2 (i.e., arranged in an offset manner one in proximity to the other) are configured to interact reciprocally so as to promote the temporary closure of the passage formed in the building.

In this case, on the second frames 41, respective recesses 53 are formed, positioned at the protruding portion 47.

The positioning of the recesses 53 is chosen in such a way as to be mutually facing when the doors 2 are brought together, i.e., when the planes π, π′ on which the respective second frames lie are aligned (and substantially coplanar).

This condition is clearly visible in FIG. 10.

The coupling means 50 may comprise respective closure elements 54 shaped so as to define a hollow form; these elements 54 are made of at least partially yielding material and are suitable for being housed in the recesses 53 formed on the protruding portion 47 of the second frames 41.

When the protruding portions 47 are in an aligned position (i.e., when the respective planes π, π′ are aligned), these closure elements 54 interact with each other so as to be inserted at least partially one inside the other, thus promoting the temporary union of the two doors 2.

Conversely, when the user applies a pair of opposing forces to the doors 2, thanks to the relatively yielding material of which the closure elements 54 are made, it will be possible to obtain their disengagement, thus promoting their detachment.

At the moment when the closure elements 54 are in a condition of reciprocal separation, the user may promote the sliding of the doors 2 along their respective direction S.

### Support Plate (or Base)

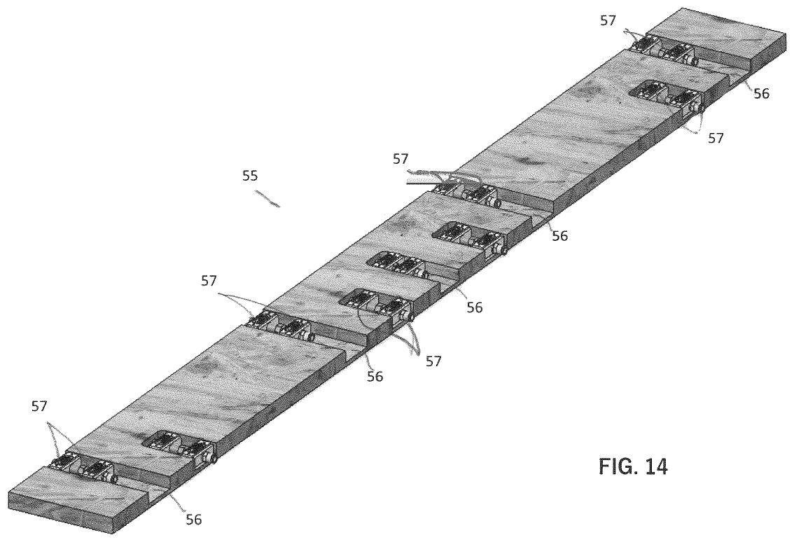

Suitably, below the base elements 9 positioned in proximity to the floor, a support plate (or base) 55 may be positioned, of the type illustrated in FIG. 14. This plate or base 55 may be made of thermally insulating material so as to increase the thermal efficiency of the entire frame structure 1.

This plate 55 may have a series of transverse channels 56 for the drainage of liquid fractions (e.g., water, condensation, etc.) that could collect downwards during the seasons, or due to atmospheric events (e.g., the dripping of rainwater that hits the panel of the door 2).

At each drainage channel 56, a unidirectional valve 57 is located, suitable for allowing the passage into the channel of the liquid fraction coming from the assembly 1 and which passes through the first frame 5 or collects in it.

Suitably, the function of the drainage channels 56 is to define a drainage system for the liquids that interact with the frame structure 1 or for the condensation that forms at it; the liquids collected in the channels 56 then flow from the valves 57 towards the outside through suitable pipes directly connected to the valves themselves (these pipes are not illustrated in the Figures).

However, the unidirectional valves 57 allow blocking the passage of the liquid fraction in the opposite direction, preventing any liquids present outside the assembly 1 from flowing back through the drainage channel 56 and partially or totally flooding the first frames 5.

Furthermore, the unidirectional valves also allow blocking the flow of air from the outside to the inside, i.e., from the external environment with respect to the frame structure to the internal environment with respect to said structure.

### Thermal Insulation Means

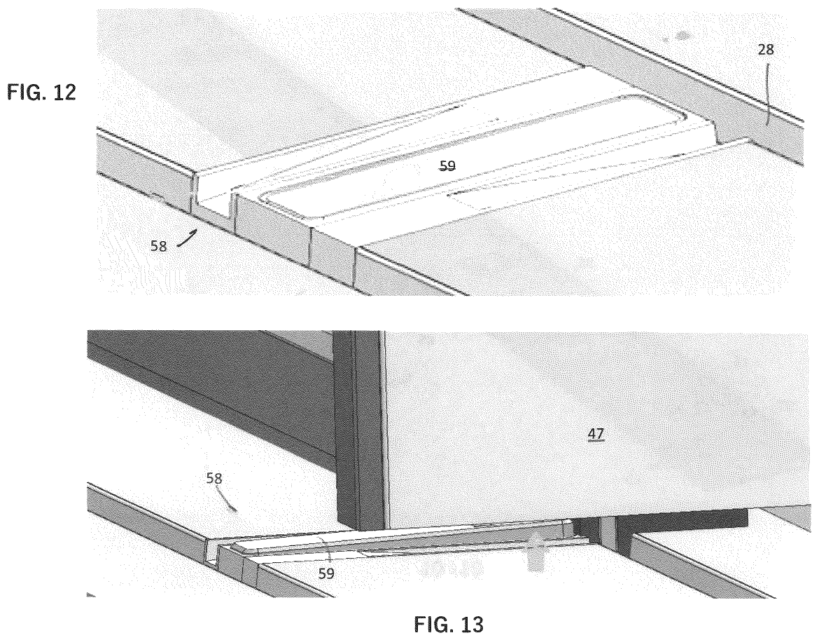

In order to improve the thermal insulation provided by the assembly with respect to the external environment, suitable thermal insulation means 58 may be provided, which are better visible in FIG. 12 and FIG. 13. The insulation means 58, moreover, allow insulating the entire frame structure 1 with respect to the possible permeability of liquids (and in particular, water).

In particular, the insulation means 58 may comprise a block 59 made of ferromagnetic material; this block 59 is intended to be housed in a suitable recess formed on the first frames 5 in proximity to the slot 28.

This block 59 is arranged in such a way as to be oriented along a direction substantially orthogonal to the development direction of the slot 28.

Furthermore, this block 59 may generally be located in the vicinity of the lateral wall that delimits the passage formed in the building, so as to be in proximity to the second frame 41 associated with the door 2 when the latter is positioned so as to promote the substantial closure of the passage.

In fact, the block 59 will be substantially aligned with the protruding portion 47 of the second frame 41 associated with the sliding door 2 when the latter is adjacent to the lateral wall that delimits the passage formed in the building.

The block 59 may be free to move vertically in a selective manner; furthermore, at the lower end of the protruding portion 47 of the second frame 41, a magnet may be located (not visible in the Figures), suitable for interacting with the block 59.

When the protruding portion 47 of the second frame 41 aligns with the block 59 (following the movement of the door 2 along the sliding direction S), the magnetic attraction force applied by the magnet to the block 59 itself will be of such a value as to promote its lifting in order to bring it into contact with the lower edge of the protruding portion 47 of the second frame 41.

The lifting of the block 59 in fact promotes the closure of the air gap that is established between the lower edge of the protruding portion 47 and the floor, thus allowing a condition of thermal insulation to be established between the environments located on opposite sides with respect to the passage formed in the building.

Suitably, the block 59 may have a predetermined length chosen so as to occupy the entire distance that separates two contiguous slots 28 formed at the first frames 5.

In this way, the same block 59 can interact selectively with a single door 2 that slides along one of the respective slots 5.

This condition is visible in FIG. 13, where only a part of the block 59 is lifted by the attractive force generated by a magnet arranged on the protruding portion 47 associated with a single door.

However, should the protruding portions 47 associated with two respective doors 2 be aligned with each other, and arranged exactly above said block 59, the latter would be completely lifted (i.e., for its entire length) from the moment that a pair of attractive forces generated by respective magnets, each anchored to a respective protruding portion 47 of the second frame 41, is applied to it.

Suitably, the insulation means 58 described above may be configured to be installed in a totally flexible manner both at the floor and at the ceiling, without this modifying the operation as described above.

The present invention can be realized in other variants all falling within the scope of the claimed and described inventive characteristics; these technical characteristics can be replaced by other technically equivalent elements and the materials used; the shapes and dimensions of the invention can be any, provided they are compatible with its use.

The reference numbers and signs inserted in the claims and in the description have the sole purpose of increasing the clarity of the text and should not be considered as elements that limit the technical interpretation of the objects or processes identified by them.

The invention claimed is:

1. A frame assembly configured to be installed in an opening formed in a building and delimited by one or more floor portions and/or one or more ceiling portions, the frame assembly comprising:
a sliding door configured to slide along a predetermined sliding direction, the sliding door having a lower edge portion configured to be directed towards a floor and an upper edge portion configured to be directed toward a ceiling;
a first frame configured to be positioned at an opening below the lower edge portion and/or above the upper edge portion of the sliding door; and
guide means associated with the sliding door and the first frame to enable a selective sliding of the sliding door along the predetermined sliding direction,
wherein the first frame comprises an end seat facing the lower edge portion and/or the upper edge portion of the sliding door, the end seat being configured to house the one or more floor portions and/or the one or more ceiling portions to enable a positioning of the first frame completely below the floor and/or completely above the ceiling.

2. The frame assembly according to claim 1, wherein the first frame comprises one or more base elements and at least one lateral profile operatively connected to at least one of the one or more base elements, the end seat being formed in the at least one lateral profile.

3. The frame assembly according to claim 1, wherein each base element comprises a pair of shaped profiles provided with a protruding edge and an intermediate element, the intermediate element being configured to connect the pair of shaped profiles to each other to realize a unitary base element obtained from a union of the pair of shaped profiles and the intermediate element.

4. The frame assembly according to claim 1, further comprising at least one intermediate profile provided with a central recess for housing a pair of respective protruding edges of respective base elements belonging to two base elements arranged in a mutually adjacent position, the end seat being formed in the intermediate profile.

5. The frame assembly according to claim 4, wherein the intermediate profile is interposed between a pair of lateral profiles.

6. The frame assembly according to claim 1, wherein the end seat is delimited by a substantially flat external wall formed in each lateral profile and in each intermediate profile and by a raised edge that extends from the external wall at an end of the external wall.

7. The frame assembly according to claim 6, wherein the raised edge formed on the external wall of each lateral profile and/or of each intermediate profile is substantially orthogonal to the external wall.

8. The frame assembly according to claim 1, wherein the sliding door comprises a central panel connected to one or more second frames, each second frame comprising a profiled element and a respective elongated profile configured to house the profiled element.

9. The frame assembly according to claim 8, wherein the profiled element is made of a composite material.

10. The frame assembly according to claim 8, wherein the profiled element is a profile made of a fiber-reinforced plastic material and has a groove for housing an edge portion of the central panel.

11. The frame assembly according to claim 5, wherein the lateral profiles and/or the intermediate profile and/or a respective elongated profile are made of a metal alloy containing aluminum.

12. The frame assembly according to claim 8, further comprising a plurality of sliding doors sliding along respective sliding directions.

13. The frame assembly according to claim 12, further comprising coupling means configured to selectively couple the plurality of sliding doors in order to promote a selective closure or opening of the opening formed in the building.

14. The frame assembly according to claim 13, wherein the coupling means have a male member integral with the second frame associated with a sliding door adjacent to a lateral edge of the central panel, and a female member integral with a second frame anchored to the opening and/or associated with another sliding door adjacently to the lateral edge of the other sliding door, the male member and the female member being configured to interact reciprocally to promote a temporary union of the plurality of sliding doors.

15. The frame assembly according to claim 13, wherein the frame assembly comprises a plurality of sliding doors sliding along respective substantially parallel and mutually offset sliding directions, the second frames associated with a pair of contiguous doors being provided with a protruding portion with respect to the central panel, the protruding portion being substantially orthogonal to the respective sliding directions of the sliding doors.

16. The frame assembly according to claim 15, wherein the protruding portions of the second frames have respective recesses positioned so as to be mutually facing, the coupling means comprising respective closure members made of an at least partially yielding material and configured to be mutually coupled when the second frames of the sliding doors are in a substantially aligned position.
